(19) United States
(12) Patent Application Publication
(10) Pub. No.: US 2021/0403209 A1
(43) Pub. Date: Dec. 30, 2021

(54) SOLUBLE FOOD DELIVERY SYSTEM

(71) Applicant: Eran Oz, Uxbridge (CA)

(72) Inventor: Eran Oz, Uxbridge (CA)

(73) Assignee: Eran Oz, Uxbridge (CA)

(21) Appl. No.: 17/361,067

(22) Filed: Jun. 28, 2021

Related U.S. Application Data
(60) Provisional application No. 63/044,642, filed on Jun. 26, 2020.

(51) Int. Cl. B65D 47/36; B65D 81/32; A61J 9/00; B65D 51/28

(52) U.S. Cl. CPC B65D 47/36; B65D 51/2821; A61J 9/00; B65D 81/3222

(57) ABSTRACT

Disclosed herein is a package having: a housing defining a body and a container; a frangible closure which, in combination with the body, defines a soluble compartment; a frangible closure which, in combination with the container, defines a water compartment separate from the soluble compartment; a quantity of a soluble contained within the soluble compartment; and a quantity of water contained within the water compartment and which, if mixed with the soluble contained in the soluble compartment, produces an ingestible.

### RELATED APPLICATION

This application claims the benefit under 35 U.S.C. § 119(e) of U.S. provisional application Ser. No. 63/044,642, filed Jun. 26, 2020, the contents of which are incorporated by reference herein in their entirety.

### FIELD OF THE INVENTION

The present disclosure relates to the field of soluble ingestibles, such as baby formula.

### BACKGROUND OF THE INVENTION

It is known to provide solubles, which can be mixed with water to produce foods. A commonplace use of this is baby formula soluble. An advantage of baby formula soluble is that the vitamins contained in the soluble do not quickly degrade in storage. In contrast, once baby formula has been prepared, the vitamins therein relatively quickly degrade, due to contact with water.

### SUMMARY OF THE INVENTION

Forming one aspect of the present disclosure is a package comprising: a housing defining a body and a container; a frangible closure which, in combination with the body, defines a soluble compartment; a frangible closure which, in combination with the container, defines a water compartment separate from the soluble compartment; a quantity of a soluble contained within the soluble compartment; and a quantity of water contained within the water compartment and which, if mixed with the soluble contained in the soluble compartment, produces an ingestible.

According to another aspect, the soluble can be a baby formula powder.

According to another aspect of the present disclosure: a membrane can define the frangible closures; the body can include a cylindrical portion, one of the ends of the cylindrical portion being occluded by the membrane; the container can circumferentially surround the body and can have an annular end occluded by the membrane; and the container can have an exteriorly threaded outer surface adjacent the annular end.

Forming another aspect of the present disclosure is an adapter for use with the package, and also for use with a baby bottle of the type which terminates in an open, exteriorly-threaded end, the threaded end being adapted for threaded receipt of a collar, the collar being adapted to secure a nipple to the bottle, the adapter comprising: a coupler portion adapted to receive the housing, in use, in sealed relation; a cutter portion adapted to, in use, fracture the frangible closures as the coupler receives the housing; and a receiver portion adapted to, in use, threadingly receive the threaded end of the bottle and provide, when the receiver portion is in receipt of the threaded end of the bottle and the coupler is in receipt of the housing, for communication between the interior of the bottle and the interiors of the body and container of the package.

According to another aspect of the present disclosure, the adapter can further comprise a mesh disposed intermediate the coupler portion and the receiver portion.

Forming another aspect of the present disclosure is
a package comprising: a housing defining a body and a container; a frangible closure which, in combination with the body, defines a soluble compartment; a frangible closure which, in combination with the container, defines a water compartment separate from the soluble compartment; a quantity of soluble contained within the soluble compartment; and a quantity of water contained within the water compartment and which, if mixed with the soluble contained in the soluble compartment, produces a foodstuff,
wherein
a membrane defines the frangible closures; the body includes a cylindrical portion, one of the ends of the cylindrical portion being occluded by the membrane; the container circumferentially surrounds the body and has an annular end occluded by the membrane; and the container has an exteriorly threaded outer surface adjacent the annular end.

Forming another aspect of the present disclosure is an adapter that can be used with this package and also with a baby bottle of the type which terminates in an open, exteriorly-threaded end, the threaded end being adapted for threaded receipt of a collar, the collar being adapted to secure a nipple to the bottle. This adapter comprises:
an interiorly-threaded coupler portion adapted to receive the threaded outer surface of the container, in use, in sealed relation;
a cutter portion adapted to, in use, fracture the frangible closures as the coupler threadingly receives the housing; and
a receiver portion adapted to, in use, threadingly receive the threaded end of the bottle and provide, when the receiver portion is in receipt of the threaded end of the bottle and the coupler is in receipt of the housing, for communication between the interior of the bottle and the interiors of the body and container of the package.

According to another aspect of the present disclosure, this adapter can further comprise a mesh disposed intermediate the coupler portion and the receiver portion.

According to another aspect of the present disclosure, in this adapter, the cutter portion can be disposed intermediate the coupler portion and the receiver portion.

According to another aspect of the present disclosure, the cutter portion can be disposed intermediate the mesh and the coupler portion.

According to another aspect of the present disclosure, the cutter portion can include: a hollow syringe disposed centrally with respect to the interiorly threaded portion of the coupler and in spaced relation to the mesh and which, when the coupler is in receipt of the housing, is disposed in close-fitting relation within the cylindrical portion of the housing; and a barb disposed radially-outwardly from the syringe and which, when the coupler is in receipt of the housing, projects into the annular end of the container.

Forming yet another aspect of the present disclosure is a system comprising packages and adapters. Further advantages, features and characteristics of the present disclosure will become apparent upon a review of the following detailed description and the appended drawings, the latter being briefly described hereinafter.

### BRIEF DESCRIPTION OF THE DRAWINGS

FIG. 1 is a view showing the components of a system according to an exemplary embodiment of the present disclosure

FIG. 2 is a side view of the structure of encircled area 2 of FIG. 1

FIG. 3 is a view along section 3-3 of FIG. 2

FIG. 4 is a side view of the structure of encircled area 4 of FIG. 1

FIG. 5 is a view along section 5-5 of FIG. 3

FIG. 6 is an exploded view of the structure of encircled area 3 of FIG. 1

FIG. 7 is an exploded view of a baby bottle system of the prior art

FIG. 8 is a view of the structures of FIG. 1 in use with the structure of encircled area 8 of FIG. 7

FIG. 9 is a view along section 9-9 of FIG. 8

FIG. 10 is a perspective view of the structure of encircled area 10 of FIG. 8

FIG. 11 is a perspective view of the structure of FIG. 9

FIG. 12 is an exploded view of the structure of FIG. 10.

### DETAILED DESCRIPTION OF THE EXEMPLARY EMBODIMENT

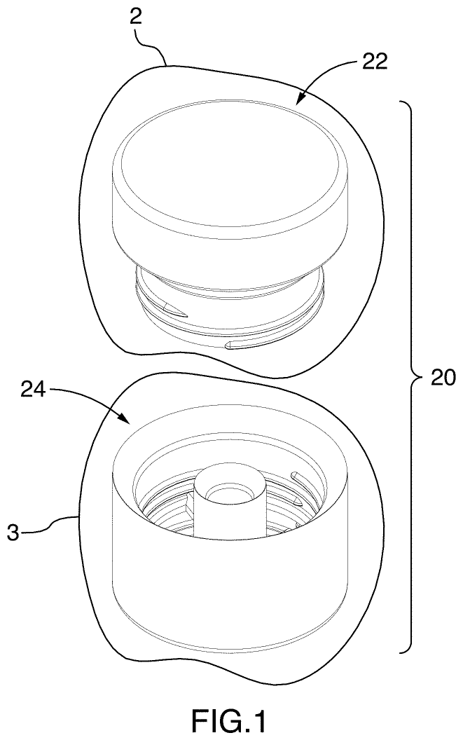

Reference is now made to FIG. 1 which shows, as previously indicated, the components of a system 20 according to the exemplary embodiment, namely, packages 22 and adapters 24.

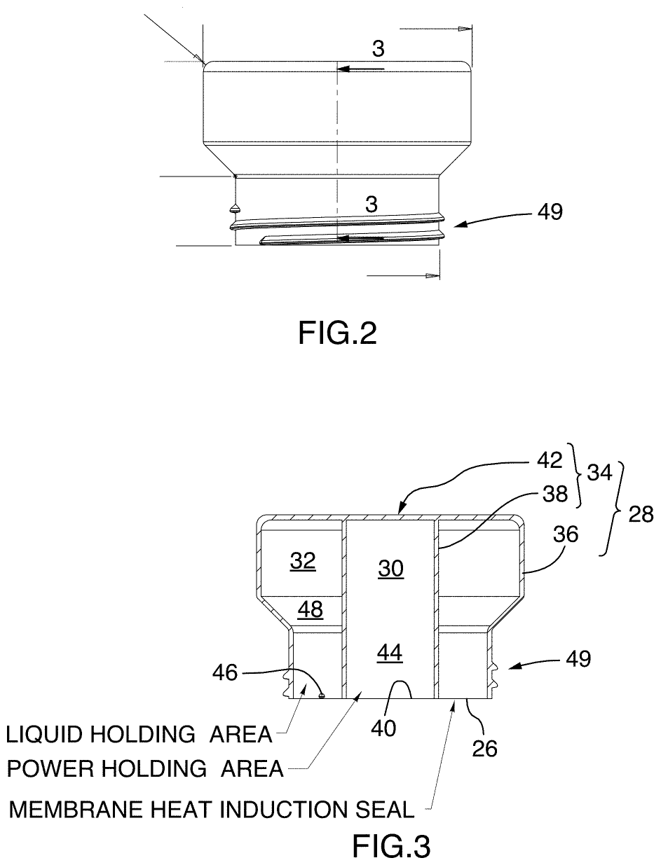

The package 22 will be seen in FIGS. 2-3 to include a membrane 26, a housing 28, a quantity of baby formula soluble 30 and a quantity of water 32.

The membrane 26 is a heat sealed plastic film.

The housing 28 defines a body 34 and a container 36.

The body 34 includes a cylindrical portion 38. One 40 of the ends 40,42 of the cylindrical portion 38 is occluded by the membrane 26 to define a soluble compartment 44.

The container 36 circumferentially surrounds the body 34 and has (i) an annular end 46 occluded by the membrane 26 to define a water compartment 48; and (ii) an exteriorly threaded outer surface 49 adjacent the annular end 46.

The quantity of soluble 30 is sterile and hermetically contained within the soluble compartment 44. The quantity of water 32 is sterile and hermetically contained within the water compartment 48; it will be understood that the water 32, if mixed with the baby formula soluble 30 contained in the soluble compartment 44, produces baby formula.

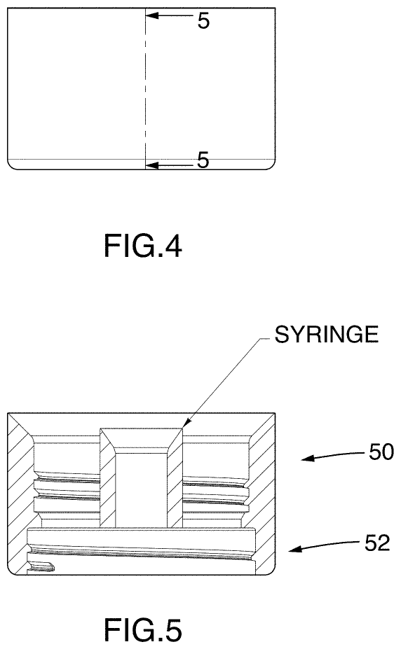

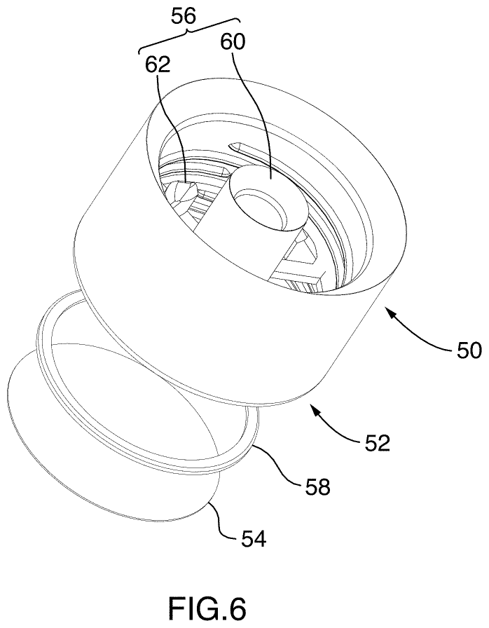

Turning now to the adapters 24, same will be seen in FIGS. 4-6 to generally include a coupler portion 50, a receiver portion 52, a mesh 54 and a cutter portion 56.

The coupler portion 50 is interiorly threaded.

The receiver portion 52 is interiorly threaded and communicates with the coupler portion 50.

The mesh 54 is disposed intermediate the coupler portion 50 and the receiver portion 52 and is peripherally supported by a ring 58.

The cutter portion 56 is disposed intermediate the coupler portion 50 and the receiver portion 52 and includes a syringe 60 and a barb 62.

The syringe 60 is hollow and is disposed centrally with respect to the interiorly threaded portion of the coupler 50 and in spaced relation to the mesh 54.

The barb 62 is disposed radially-outwardly from the syringe 60.

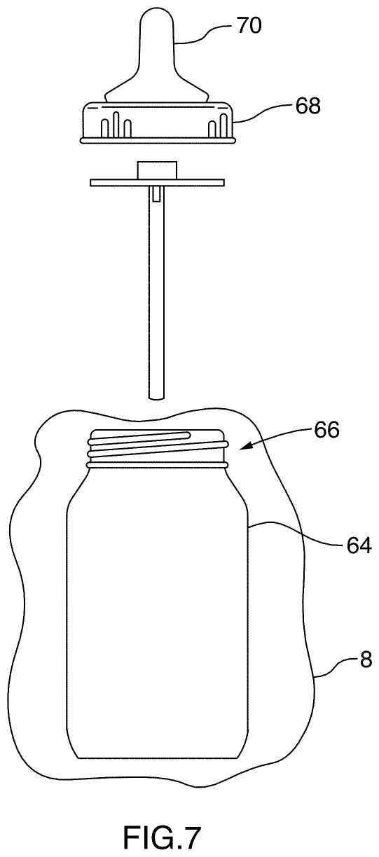

It should be understood that the components are adapted for use with a baby bottle 64 of the type shown in FIG. 7 which terminates in an open, exteriorly-threaded end 66, the threaded end 66 being adapted for threaded receipt of a collar 68, the collar 68 being adapted to secure a nipple 70 to the bottle 64.

For use, the receiver portion 52 is threadingly engaged to the threaded end 66 of the bottle 64, and thereafter, the coupler portion 50 is threadingly engaged to the annular threaded end 49 of the container 36. As the coupler portion 50 is threaded to the container 36, the syringe 60 fractures the membrane 26 overlying the cylindrical portion 38 and enters, in close-fitting relation, the cylindrical portion 38 of the package 20, and thereafter, the barb 62 fractures the membrane overlying the container 36 and enters the container 36, thereby providing for communication

i. between the interiors of the body 34 and container 36 of the package 22; and

ii. via the mesh 54, between the package 22 and the bottle 64

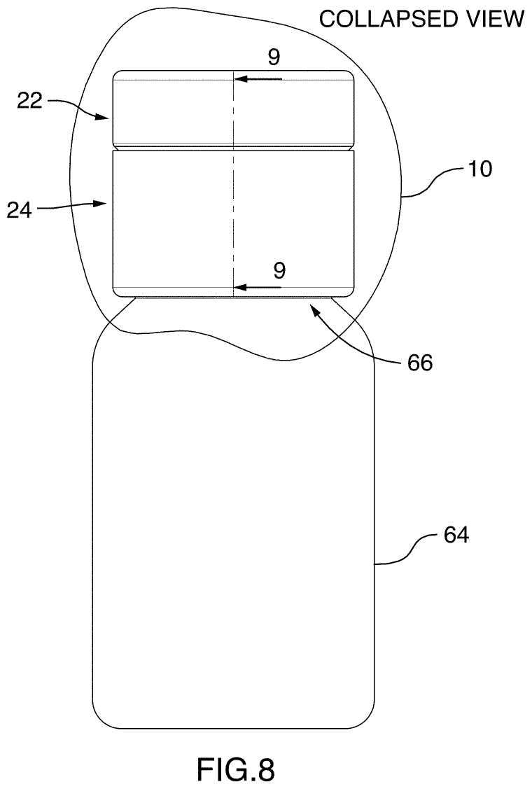

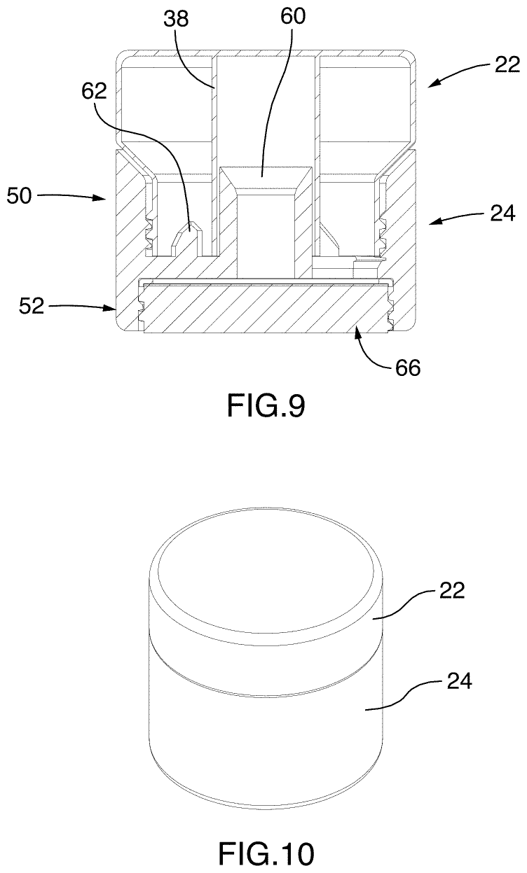

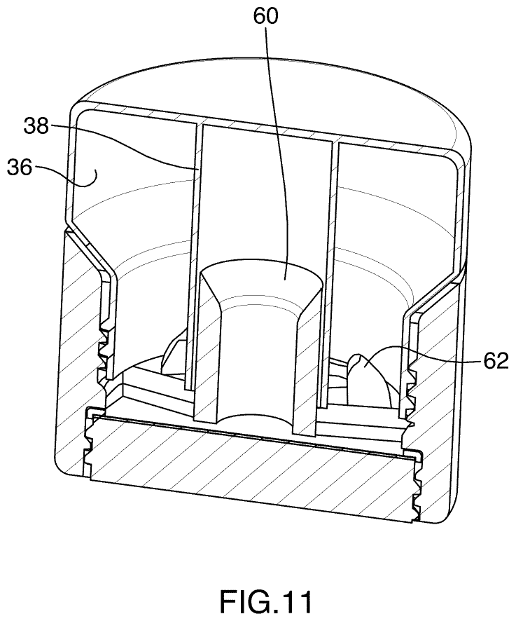

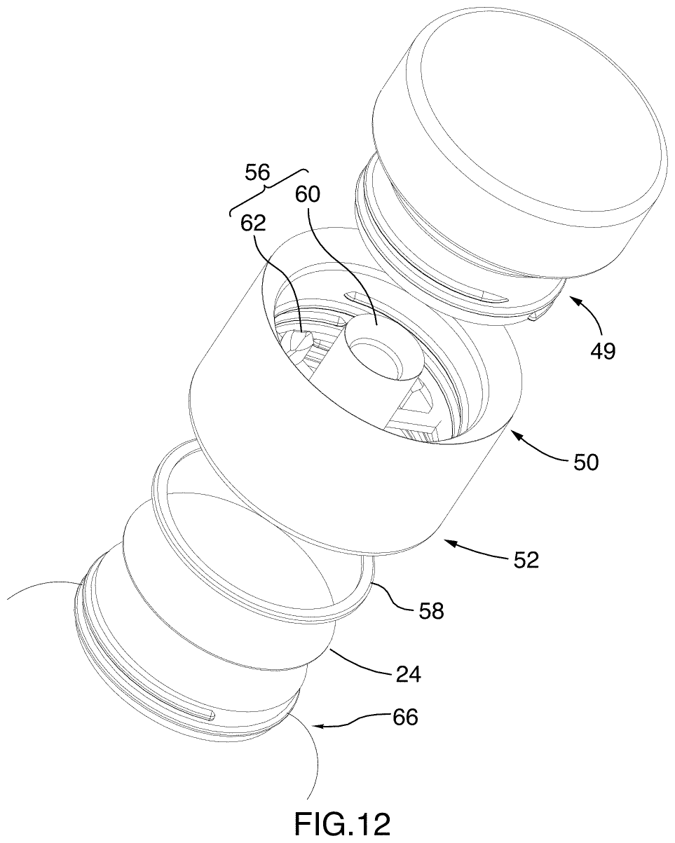

Hand agitation of the assembly shown in FIG. 8 causes admixture of the soluble and the water to produce baby formula which, when the assembly is orientated with the bottle beneath the package, as shown, drains into the bottle, through the mesh, which ensures that no lumps enter the bottle.

The components of the system can thereafter be removed from the bottle and the nipple and collar placed thereupon, to allow an infant to be fed.

Without intending to be bound by theory, it is believed that the system provides an advantageous combination of features including:
no special storage conditions
eliminate need for sterilization
compatible with many bottle brands
easily modified to any bottle
avoid need for measurement
package can be disposable

### EMBODIMENTS

Embodiment 1. A package comprising:
a housing defining a body and a container;
a frangible closure which, in combination with the body, defines a soluble compartment;
a frangible closure which, in combination with the container, defines a water compartment separate from the soluble compartment;
a quantity of a soluble contained within the soluble compartment; and
a quantity of water contained within the water compartment and which, if mixed with the soluble contained in the soluble compartment, produces an ingestible.

Embodiment 2. A package according to Embodiment 1, wherein the soluble is a baby formula powder.

Embodiment 3. A package according to Embodiment 2, wherein:
a membrane defines the frangible closures;
the body includes a cylindrical portion, one of the ends of the cylindrical portion being occluded by the membrane;
the container circumferentially surrounds the body and has an annular end occluded by the membrane; and
the container has an exteriorly threaded outer surface adjacent the annular end.

Embodiment 4. An adapter for use with the package of Embodiment 2, and also for use with a baby bottle of the type which terminates in an open, exteriorly-threaded end, the threaded end being adapted for threaded receipt of a collar, the collar being adapted to secure a nipple to the bottle, the adapter comprising:
a coupler portion adapted to receive the housing, in use, in sealed relation;
a cutter portion adapted to, in use, fracture the frangible closures as the coupler receives the housing; and
a receiver portion adapted to, in use, threadingly receive the threaded end of the bottle and provide, when the receiver portion is in receipt of the threaded end of the bottle and the coupler is in receipt of the housing, for communication between the interior of the bottle and the interiors of the body and container of the package.

Embodiment 5. The adapter according to Embodiment 4, further comprising a mesh disposed intermediate the coupler portion and the receiver portion.

Embodiment 6. An adapter for use with the package of Embodiment 3, and also with a baby bottle of the type which terminates in an open, exteriorly-threaded end, the threaded end being adapted for threaded receipt of a collar, the collar being adapted to secure a nipple to the bottle, the adapter comprising:
an interiorly-threaded coupler portion adapted to receive the threaded outer surface of the container, in use, in sealed relation;
a cutter portion adapted to, in use, fracture the frangible closures as the coupler threadingly receives the housing; and
a receiver portion adapted to, in use, threadingly receive the threaded end of the bottle and provide, when the receiver portion is in receipt of the threaded end of the bottle and the coupler is in receipt of the housing, for communication between the interior of the bottle and the interiors of the body and container of the package.

Embodiment 7. The adapter of Embodiment 6, further comprising a mesh disposed intermediate the coupler portion and the receiver portion.

Embodiment 8. The adapter of Embodiment 6, wherein the cutter portion is disposed intermediate the coupler portion and the receiver portion.

Embodiment 9. The adapter of Embodiment 8, wherein the cutter portion is disposed intermediate the mesh and the coupler portion.

Embodiment 10. The adapter of Embodiment 9, wherein the cutter portion comprises:
a hollow syringe disposed centrally with respect to the interiorly threaded portion of the coupler and in spaced relation to the mesh and which, when the coupler is in receipt of the housing, is disposed in close-fitting relation within the cylindrical portion of the housing; and
a barb disposed radially-outwardly from the syringe and which, when the coupler is in receipt of the housing, projects into the annular end of the container.

Embodiment 11. A system comprising:
packages according to any one of Embodiments 1 to 3; and
adapters according to any one of Embodiments 4 to 10.

Whereas a specific embodiment is shown and described, it will be understood that variations are possible.

For example, whereas a specific bottle is shown, it will be appreciated that the bottle shown is exemplary and the disclosed embodiments can be used with any baby bottle brand or format.

As well, whereas a specific shape of package is shown, it will be appreciate that variations are possible.

Further, whereas a mesh is included, this could be omitted, but this of course impacts upon functionality.

Additionally, whereas a single membrane defines frangible closures for both the body and the container, it will be appreciated that this is not essential; for example,

Yet further, whereas the description makes specific mention to baby formula powder, the present disclosure is not so limited. Free-flowing liquids and granular solubles can also be utilized, and the resultant product can be any type of ingestible, including foods, beverages and pharmaceuticals.

Accordingly, the present disclosure should be understood to be limited only by the accompanying claims, purposively construed.

1. A package comprising:
a housing defining a body and a container;
a frangible closure which, in combination with the body, defines a soluble compartment;
a frangible closure which, in combination with the container, defines a water compartment separate from the soluble compartment;
a quantity of a soluble contained within the soluble compartment; and
a quantity of water contained within the water compartment and which, if mixed with the soluble contained in the soluble compartment, produces an ingestible.

2. A package according to claim 1, wherein the soluble is a baby formula powder.

3. A package according to claim 2, wherein:
a membrane defines the frangible closures;
the body includes a cylindrical portion, one of the ends of the cylindrical portion being occluded by the membrane;
the container circumferentially surrounds the body and has an annular end occluded by the membrane; and
the container has an exteriorly threaded outer surface adjacent the annular end.

4. An adapter for use with the package of claim 2, and also for use with a baby bottle of the type which terminates in an open, exteriorly-threaded end, the threaded end being adapted for threaded receipt of a collar, the collar being adapted to secure a nipple to the bottle, the adapter comprising:
a coupler portion adapted to receive the housing, in use, in sealed relation;
a cutter portion adapted to, in use, fracture the frangible closures as the coupler receives the housing; and
a receiver portion adapted to, in use, threadingly receive the threaded end of the bottle and provide, when the receiver portion is in receipt of the threaded end of the bottle and the coupler is in receipt of the housing, for communication between the interior of the bottle and the interiors of the body and container of the package.

5. The adapter according to claim 4, further comprising a mesh disposed intermediate the coupler portion and the receiver portion.

6. An adapter for use with the package of claim 3, and also with a baby bottle of the type which terminates in an open, exteriorly-threaded end, the threaded end being adapted for threaded receipt of a collar, the collar being adapted to secure a nipple to the bottle, the adapter comprising:
an interiorly-threaded coupler portion adapted to receive the threaded outer surface of the container, in use, in sealed relation;
a cutter portion adapted to, in use, fracture the frangible closures as the coupler threadingly receives the housing; and
a receiver portion adapted to, in use, threadingly receive the threaded end of the bottle and provide, when the receiver portion is in receipt of the threaded end of the bottle and the coupler is in receipt of the housing, for communication between the interior of the bottle and the interiors of the body and container of the package.

7. The adapter of claim 6, further comprising a mesh disposed intermediate the coupler portion and the receiver portion.

8. The adapter of claim 6, wherein the cutter portion is disposed intermediate the coupler portion and the receiver portion.

9. The adapter of claim 8, wherein the cutter portion is disposed intermediate the mesh and the coupler portion.

10. The adapter of claim 9, wherein the cutter portion comprises:
a hollow syringe disposed centrally with respect to the interiorly threaded portion of the coupler and in spaced relation to the mesh and which, when the coupler is in receipt of the housing, is disposed in close-fitting relation within the cylindrical portion of the housing; and
a barb disposed radially-outwardly from the syringe and which, when the coupler is in receipt of the housing, projects into the annular end of the container.
